(19) United States
(12) Patent Application Publication
(10) Pub. No.: US 2017/0105333 A1
(43) Pub. Date: Apr. 20, 2017

(54) TYRE INFLATION SYSTEM FOR AN AGRICULTURAL SEEDING MACHINE, A PLANTER ASSEMBLY AND A TYRE

(71) Applicant: COALFIELDS ENGINEERING PTY LTD, Collie, WA (US)

(72) Inventor: Geoffrey William GLENN, Bunbury (AU)

(21) Appl. No.: 15/296,311

(22) Filed: Oct. 18, 2016

(30) Foreign Application Priority Data
Oct. 19, 2015 (AU) 2015904289

(51) Int. Cl. A01C 5/06; B60C 29/02; A01C 7/10; B60C 23/00

(52) U.S. Cl. CPC A01C 5/068; B60C 23/003; B60C 29/02; B60C 23/005; A01C 7/10; B60C 2200/08

(57) ABSTRACT

A tyre inflation system for an agricultural seeding machine is disclosed. The agricultural machine includes a jump arm supporting at least one press wheel. The tyre inflation system comprises an air delivery path arranged to be in air flow communication with a cavity of a tyre of a press wheel, and an air flow controller operable to cause a delivery of air through the air delivery path to adjust an inflation pressure of the tyre in situ during use of the agricultural machine. A planter assembly including a tyre inflation system and a tyre for use with the tyre inflation system are also disclosed.

### FIELD OF INVENTION

The present invention relates to a tyre inflation system for an agricultural seeding machine, to a planter assembly including a tyre inflation system and to a tyre for use in a tyre inflation system.

### BACKGROUND ART

Agricultural planters, also known as seed drills, are used in a one-pass application to place seed and fertilizer into soil to plant a crop in a paddock, i.e. the planter only makes a single traverse of the paddock to plough open a furrow in the soil, to deposit fertiliser in the furrow, to prepare a seed bed by partially filling the furrow with soil to cover the fertiliser, to deposit seeds onto the seed bed, and finally to fully close the furrow and applying pressure onto the soil to ensure adequate contact between the seed and the soil.

In most instances, in order to achieve proper germination of the seed it is necessary to place the seed at a substantially consistent depth beneath the soil surface. This depth is normally quite shallow, being less than 10 cm, but is occasionally required to be deeper depending on the crop being planted.

Consistent depth planting has been widely achieved in the prior art by various types of planter assemblies that are supported on a lateral plough frame. It will be appreciated that modern high-powered tractors can pull large agricultural implements and thus that a single plough frame can supported multiple planter assemblies. It is known that some smaller plough frames can support twelve to fifteen planter assemblies, whereas some larger plough frames are winged and can support more than fifty planter assemblies.

Each planter assembly normally has a tine to engage the soil to open the furrow, which is followed by a scraper to form a seed bed onto which the seed is deposited through a seed tube. In the prior art, such a scraper is also interchangeably referred to as a closing tool or an opening tool. This is due to the characteristics of the soil type. For example, when the soil is relatively rigid, e.g. clay, and the furrow formed by the tine remains open, the scraper acts as a closing tool to collapse soil into the furrow to partially close the furrow. Alternatively, when the soil is more fluid and collapses, closing the furrow immediately behind the tine before the seed tube, the scraper acts as an opening tool to reopen the furrow allowing the seed to be placed on the seed bed. Finally a press wheel runs on the soil surface and engages the sides of the furrow to collapse the furrow and cover the seed with the soil. The scraper, seed tube and press wheel are normally fixedly mounted on a separate seeding frame that is movably mounted either to the plough frame or to the tine so that the seeding frame can move vertically relative to and independently from the plough frame. Most commonly, such vertical movement is enabled by joining the seeding frame to the plough frame using a pivotable arm or parallel linkage, wherein movement of the arm or linkage is caused by the press wheel following the contour of the ground. The depth at which the seed is planted is determined by the vertical distance that the bottom of the scraper is located below the bottom of the press wheel, because the latter runs on the soil surface. Thus by altering the fixed position of the scraper relative to the position of the press wheel, the desired planting depth can be set.

Some press wheels are provided with inflatable tyres, whereas others have solid tyres. Furthermore, the tyres are normally provided in different widths and different sectional profiles, which are selected depending on the type of soil in the paddock and the type of seed being planted. Thus in clay soil that tends to compact tightly it is preferable to use a wider softer profile tyre so that the clay is not compacted too much around the seed, whereas in sandy soil that compacts less it is preferable to use a narrower harder profile tyre so that the sand is subjected to a tighter compaction around the seed. Also, during use in wet conditions a wider softer profile tyre is preferred, whereas in dry conditions a narrower harder profile tyre is preferable.

The above described background art is not intended to limit the application of the planter assembly as disclosed herein.

### SUMMARY OF THE INVENTION

According to a first aspect of the invention, there is disclosed a tyre inflation system for an agricultural seeding machine having a jump arm supporting at least one press wheel, the tyre inflation system comprising:

an air delivery path arranged to be in air flow communication with a cavity of a tyre of a press wheel; and

an air flow controller operable to cause a delivery of air through the air delivery path to adjust an inflation pressure of the tyre in situ during use of the agricultural seeding machine.

The air delivery path may be defined by: a rotary coupling mountable to the wheel; a first air flow conduit arranged to extend from the rotary coupling to the air flow controller; and a second air flow conduit for providing air flow communication between the rotary coupling and the cavity of the tyre.

The rotary coupling may be mountable on the axle of the wheel between the first and second air flow conduits.

The air flow controller may be operable to select between connecting the air delivery path to an air supply for increasing the inflation pressure of the tyre or an outlet for decreasing the inflation pressure of the tyre.

The tyre inflation system may comprise a source of compressed air as the air supply.

The air flow controller may comprise a piston movable within a cylinder to change a volume of a chamber of the cylinder, wherein the chamber is in air flow communication with the air delivery path and moving the piston causes an increase or decrease in the inflation pressure of the tyre.

The air delivery path may extend through the axle and into the tyre.

The tyre inflation system may comprise a rim of the wheel, wherein the air delivery path traverses the rim.

At least a portion of the first air flow conduit may extend through the jump arm.

At least a portion of the first air flow conduit may be flexible.

The second air flow conduit may be rigid and may extend from the rotary coupling to an inflation valve of the tyre.

The second air flow conduit may extend internally through the rim from the rotary coupling into the tyre.

The in situ adjustment of the inflation pressure of the tyre may be adapted to cause an in situ change of a cross-sectional profile of the tyre.

The rotary coupling may comprise a spindle adjoining the axle and a casing rotatably enclosing the spindle in an air tight manner.

According to a second aspect of the invention, there is provided a planter assembly for an agricultural machine, comprising:

at least one press wheel and a jump arm supporting the at least one press wheel in a manner wherein the at least one press wheel is arranged to follow a surface contour;

a pneumatic tyre mounted on each press wheel; and

a tyre inflation system according to the first aspect.

An area of the footprint of the tyre may be variable between approximately 10 cm² and 100 cm².

The tyre, when deflated to a sufficient extent, may be arranged to have a cross-sectional profile having two or more radial protuberances.

The planter assembly may comprise an agricultural implement joined either directly or indirectly to the jump arm, wherein adjustment of the inflation pressure of the tyre enables an adjustment of a working height of the agricultural implement.

The planter assembly may comprise a linkage having a first end and a second end opposite the first end, wherein the first end is pivotally connectable to a plough frame and the second end is moveable in a plane of the linkage, wherein the jump arm joins the wheel to the linkage to cause movement of the second end as the wheel follows the surface contour during use.

The planter assembly may comprise a control unit configured with predetermined settings such that an operator can select a predetermined tyre pressure corresponding to a desired tyre profile.

The planter assembly may comprise a GPS device, wherein topographical maps or soil type maps are associated with the predetermined settings and the control unit is associated with the GPS system such that inflation or deflation of the tyre occurs automatically as the planter assembly traverses the paddock.

According to a third aspect of the invention, there is provided a pneumatic tyre for use with a press wheel of an agricultural seeding machine, the pneumatic tyre comprising: a wall defining an internal cavity of the tyre when mounted on a rim of the press wheel, the wall having one or more areas of different thickness such that when pressure in the tyre is substantially reduced, a cross sectional profile of the wall deforms to a predetermined configuration as a result of the one or more areas of thickness difference.

The predetermined configuration may comprise two or more radial protuberances extending from the tyre.

The cross-sectional profile may be substantially W-shaped.

Also disclosed is a planter assembly for use with agricultural machinery, the planter assembly comprising:

a jump arm supporting a wheel, wherein the wheel is arranged to follow a surface contour;

a pneumatic tyre mounted on the wheel; and

an inflation system arranged to adjust an inflation pressure of the tyre during use.

The inflation system may comprise a control unit arranged to increase or decrease the inflation pressure of the tyre.

The inflation system may comprise a source of compressed air for use in increasing the inflation pressure of the tyre.

The wheel may comprise a rim rotatably mounted on an axle and wherein an air delivery path extends through the axle, traverses the rim and extends into the tyre.

The air delivery path may comprise a rotary coupling adjoining the axle.

The air delivery path may comprise a first air flow passage extending through the axle to the rotary coupling and a second air flow passage extending from the rotary coupling to the tyre.

The first air flow passage may comprise a conduit extending through the jump arm.

The conduit may be flexible.

The second air flow passage may comprise a rigid conduit extending from the rotary coupling to an inflation valve of the tyre.

The second air flow passage may extend internally through the rim from the rotary coupling into the tyre.

The in situ adjustment of the inflation pressure of the tyre may be adapted to cause an in situ change of a cross-section profile of the tyre.

The tyre, when substantially fully inflated, may be arranged to have a cross-section profile forming a small footprint.

The tyre, when partially deflated, may be arranged to have a cross-section profile forming a mid-sized footprint.

The tyre, when substantially deflated, may be arranged to have a cross-section profile forming a large footprint.

The tyre, when fully deflated, may be arranged to have a cross-section profile having two or more radial protuberances.

The planter assembly may comprise an agricultural implement joined either directly or indirectly to the jump arm, wherein the adjustment of the inflation pressure of the tyre enables an adjustment of a working height of the agricultural implement.

The planter assembly may comprise a parallel link having a fixed end adapted to be joined to a plough frame and an opposed movable end that is moveable in a plane of the parallel link, wherein the jump arm joins the wheel to the parallel link to cause movement of the movable end as the wheel follows the surface contour during use.

Also disclosed is a method of operating a planter assembly comprising the steps of providing a planter assembly as described herein, and of inflating the tyre to decrease a footprint of the tyre to thereby increase a compression pressure applied to soil by the wheel.

The method may comprise the step of partially deflating the tyre to increase its footprint to thereby decrease a compression pressure applied to soil by the wheel.

The method may comprise the step of deflating the tyre to cause two or more radial protuberances to project from the tyre.

The method may comprise the step of at least partially deflating the tyre to a sufficient extent that its cross-section profile changes during rotation of the wheel, and rotating the wheel to cause shedding of mud that has adhered to the tyre during use.

The method may comprise the step of changing an inflation pressure within the tyre, during use to cause incremental changes to an operative height of a share joined either directly or indirectly to the jump arm.

The method may comprise the step of changing an inflation pressure within the tyre, during use to maintain a constant height position of a closing tool joined to the jump arm as the planter assembly traverses different soil types in a paddock.

Also disclosed is a tyre inflation system of a planter assembly having an axle and a wheel mounted on the axle, the tyre inflation system comprising:

a rim rotatably mounted on the axle;

a pneumatic tyre mounted on the rim and enclosing an annular tyre cavity;

a rotary coupling adjoining the axle;

a first air flow passage extending through the axle leading to the rotary coupling; and

a second air flow passage extending from the rotary coupling to the tyre cavity;

wherein the first air flow passage, the rotary coupling and the second air flow passage define an air delivery path enabling inflation or deflation of the tyre.

The tyre inflation system may comprise control unit arranged to control operation of the inflation system.

The tyre inflation system may comprise a source of compressed air in selective flow communication with the air delivery path.

The rotary coupling may comprise a spindle adjoining the axle and a casing rotatably enclosing the spindle in an air tight manner.

The first air flow passage may comprise a conduit arranged to extend through a jump arm of the planter assembly.

The conduit may be flexible.

The second air flow passage may comprise a rigid conduit extending from the rotary coupling to an inflation valve of the tyre.

The second air flow passage may extend internally through the rim from the rotary coupling to the tyre cavity.

The tyre, when substantially fully inflated, may be arranged to have a cross-section profile forming a small footprint.

The tyre, when partially deflated, may be arranged to have a cross-section profile forming a mid-sized footprint.

The tyre, when substantially deflated, may be arranged to have a cross-section profile forming a large footprint.

The tyre, when fully deflated, may be arranged to have a cross-section profile forming a W-shaped footprint having two radial protuberances.

Also disclosed is a pneumatic tyre for use with a press wheel of a planter assembly, comprising a tread and a sidewall wherein, when the tyre is substantially deflated, the tread and sidewall are arranged to deform so that two or more radial protuberances project from the tyre.

The radial protuberances may form a W-shaped cross-section profile in the tyre.

### BRIEF DESCRIPTION OF DRAWINGS

The present invention will now be described, by way of example, with reference to the accompanying schematic drawings, in which:

FIG. 1 is a perspective view of a planter assembly according to an embodiment of the invention;

FIG. 2 is a right side view of the planter assembly seen along arrow II in FIG. 1;

FIG. 3 is an enlarged scale cut-away perspective view of a press wheel arrangement of the planter assembly seen along arrow III in FIG. 1;

FIG. 4 is a cross sectional view of a tyre of the press wheel arrangement of FIG. 3 in an inflated first configuration;

FIG. 5 is a cross sectional view of the tyre in a partially deflated second configuration;

FIG. 6 is a cross sectional view of the tyre in a substantially deflated third configuration;

FIGS. 7A to 7E each show a cross sectional view of a tyre in accordance with embodiments of the present invention;

FIG. 8 is a block diagram of a tyre inflation system for a planter assembly according to an embodiment of the invention.

FIG. 9A is a block diagram of a tyre inflation system according to another embodiment of the invention;

FIG. 9B is a schematic diagram of valve positions of a three-way valve of the tyre inflation system.

FIG. 10A is a block diagram of a tyre inflation system according to another embodiment of the present invention; and

FIG. 10B is a schematic diagram of a piston and cylinder assembly for use in an embodiment of the tyre inflation system.

### DETAILED DESCRIPTION OF THE DRAWINGS

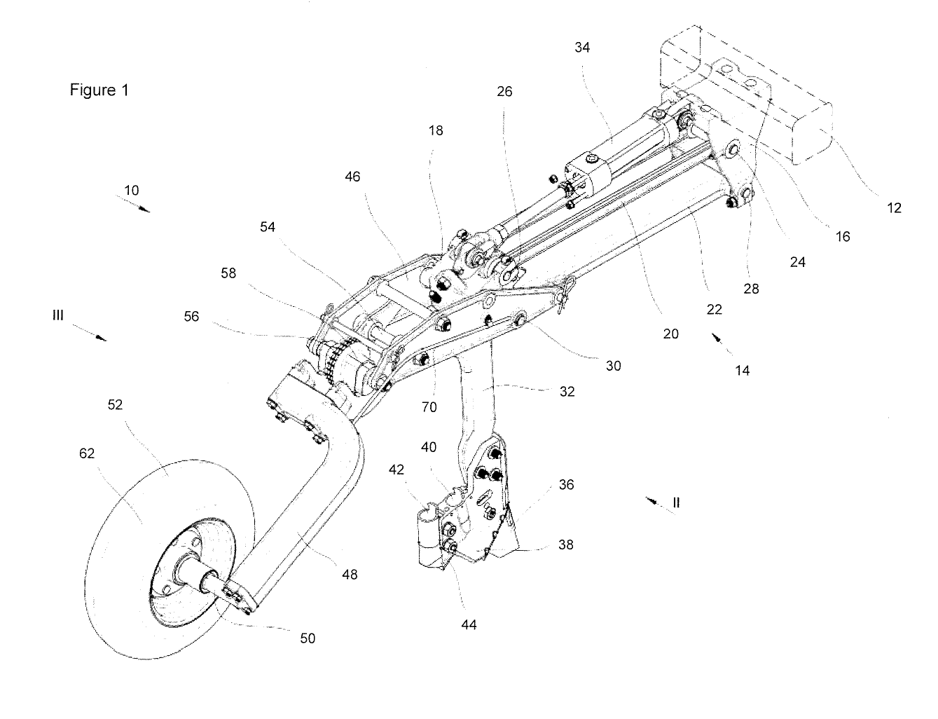

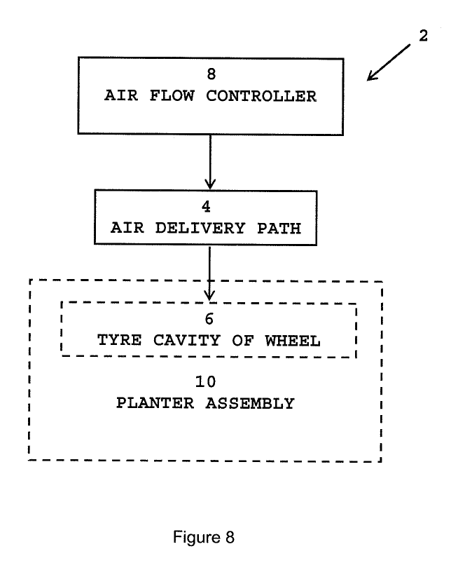

Referring to FIGS. 1, 2 and 8 of the drawings, there is shown a planter assembly 10 of an agricultural machine, the planter assembly 10 provided with a tyre inflation system 2 in accordance with an embodiment of the invention. The tyre inflation system 2 comprises an air delivery path 4 arranged to be in air flow communication with a cavity 6 of a tyre of a wheel. The tyre inflation system 2 further comprises an air flow controller 8 operable to cause delivery of air through the air delivery path to adjust an inflation pressure of the tyre in situ during use of the agricultural machine. In other words, while the agricultural machine is in use, for example in a paddock, the tyre inflation system 2 allows for the tyre to be deflated or inflated. This provides the advantage of being able to change an amount of tread and thus pressure exerted on underlying soil of a press wheel.

The planter assembly 10 in this example is adapted to be attached to a plough frame 12. It will be appreciated that only one lateral beam of the plough frame 12 is shown, however, the plough frame itself can be much larger and will comprise additional conventional plough frame features that do not form part of the invention and as such are not shown. Such additional plough frame features may include, amongst others, a tow hook for attaching the plough frame 12 to a tractor and running wheels to carry the plough frame 12 on the ground. Furthermore, the plough frame 12 can support multiple planter assemblies 10 arranged adjacent to each other and can further include multiple rows of such adjacently arranged planter assemblies 10, wherein the planter assemblies 10 in each row are laterally offset from those in other rows.

The planter assembly 10 in this example also includes a linkage 14 arranged to be joined to the plough frame 12. In use, the plough frame 12 pulls the planter assembly 10 in a forward-going direction of the agricultural machine. The linkage 14 includes a mounting bracket 16 that is joined to a link bracket 18 by an upper link arm 20 and a lower link arm 22. The mounting bracket 16 is adapted to be fixedly mounted to the plough frame 12 by suitable bolts and nuts. In this example, the upper link arm 20 and the lower link arm 22 are arranged parallel to each other and thus the linkage may be referred to as a parallel linkage 14. The upper link arm 20 is pivotally joined to the mounting bracket 16 at fore upper pivot 24 and is pivotally joined to the link bracket 18 at rear upper pivot 26. Similarly, the lower link arm 22 is pivotally joined to the mounting bracket 16 at fore lower pivot 28 and is pivotally joined to the link bracket 18 at rear lower pivot 30. Accordingly, the parallel linkage 14 enables the link bracket 18 to move up and down relative to the mounting bracket 16, while maintaining its angular orientation with respect to the mounting bracket 16.

The link bracket 18 is pivotally joined to an agricultural implement in the form of a shank 32 that is normally in a substantially upright orientation. A ram or cylinder 34 extends between the mounting bracket 16 and a head of the shank 32 to normally bias the shank 32 in its upright orientation. It will be appreciated that the shank 32 can be substituted by other types of agricultural implements, e.g. rakes or watering sprayers.

At its lower end the shank 32 carries a tine 36, which can be provided with wearing plates on its operative forward edge to improve resistance to frictional wearing of the tine 36 during use. A boot bracket 38 is mounted to the tine 36 and is arranged to carry a seed boot 40 and a fertiliser boot 42 that are normally linearly aligned behind the tine 36. Although not shown in the drawings, a fertiliser tube is joined to and extends upwardly from the fertiliser boot 42 and is arranged for conveying fertiliser from a supply hopper to be dispensed through the fertiliser boot 42. Similarly, a seed tube is joined to and extends upwardly from the seed boot 40 and is arranged for conveying seed from an air seeder hopper to be dispensed through the seed boot 40. A closing scraper 44 is carried forward of the seed boot 40 and is adapted in use to form a seed bed onto which seed exiting the seed boot 40 can fall.

Further pivotally mounted at rear lower pivot 30 is a press wheel arrangement that comprises a locking frame 46 that carries the jump arm 48 leading to an axle 50, onto which the press wheel 52 is rotatably mounted. Press wheel 52 is substantially linearly aligned with tine 36 and seed boot 42 when viewed from behind. The press wheel 52 is arranged to follow a surface contour of a soil layer in the paddock to cause movement of the link bracket through the plane, while simultaneously closing a furrow formed by tine 34 to compact soil around seed placed into the furrow through seed boot 42.

Jump arm 48 is pivotally joined to locking frame 46 at jump arm pivot 54 to extend downwardly and rearwardly from locking frame 46. An adjustment cog 56 comprising a cam 58 enables the angular position of the jump arm 48 to be adjusted and locked with respect to the locking frame 46 so that the desired depth of seed bed formed by the closing scraper 44 can be set.

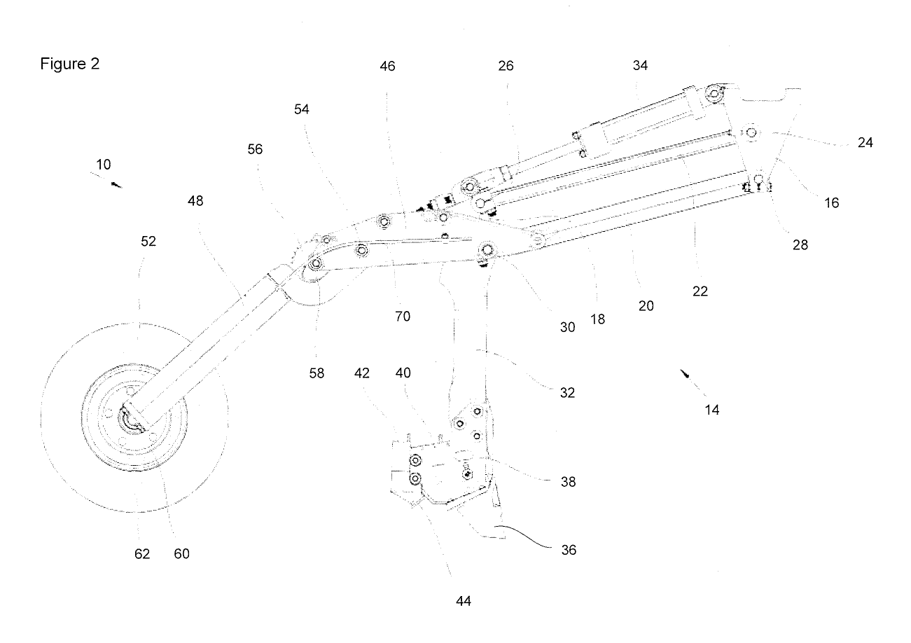

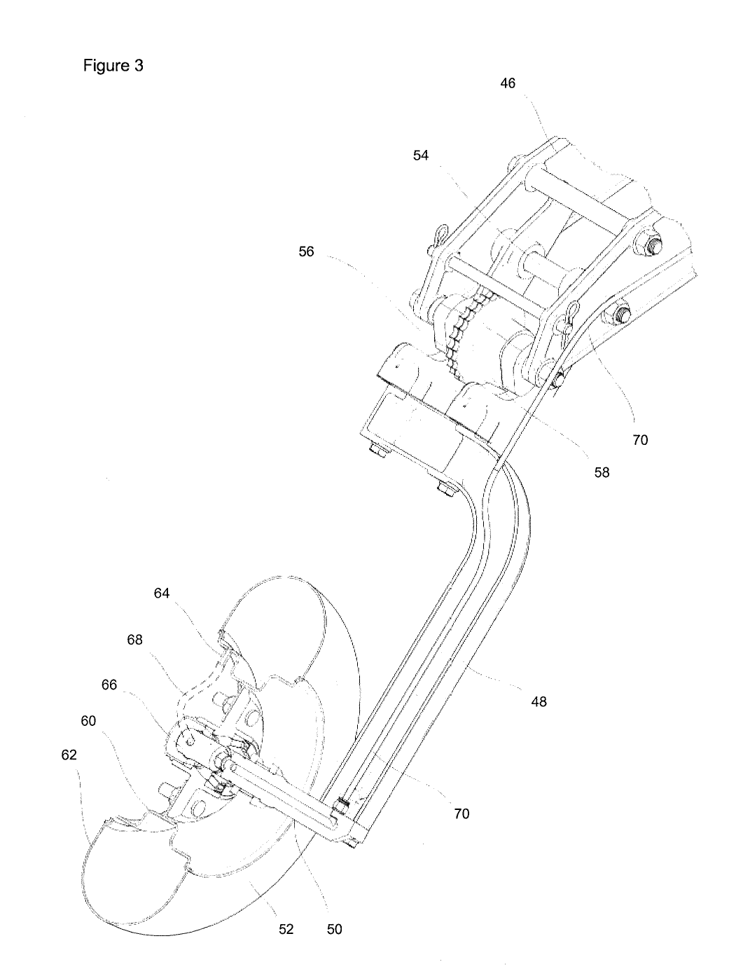

With reference to FIGS. 2 and 3, press wheel 52 has a hub or rim 60 onto which is mounted the pneumatic tyre 62 enclosing the annular tyre cavity 6. A conventional tyre inflation valve 64 extends through rim 60 into the tyre cavity 6 to permit inflation or deflation of the tyre 62. It will be appreciated that throughout the specification, the terms “inflation” and “deflation” includes partial inflation and partial deflation. A rotary coupling 66 is mounted to the wheel, in particular onto axle 50 of the wheel, and is joined in fluid flow communication to inflation valve 64 via a link conduit 68. Rotary coupling 66 is further in fluid flow communication with a pneumatic control unit (not shown) via a supply conduit 70 that extends through axle 50. As shown particularly in FIG. 3, supply conduit 70 in this example is arranged to extend from axle 50 internally through the jump arm 48 and then externally of locking frame 46. Accordingly the air delivery path 4 is defined by the rotary coupling, link conduit 68 and the supply conduit 70. It will be appreciated that supply conduit 70 can be arranged in numerous other manners and is merely required to be connected to the pneumatic control unit. Rotary coupling 66 has an internal spindle rotatably enclosed in an airtight manner within an external casing so that the spindle can remain stationary together with axle 50, while the casing rotates together with the rim 60.

In the exemplary embodiment the link conduit 68 is made of a rigid, sturdy material, such as steel tubing, so that it cannot become damaged or punctured in the harsh environment through which the press wheel 62 runs. Supply conduit 70 will be made of a flexible material so that it permits pivotal adjustment of the jump arm 48 relative to locking frame 46 as well as catering for planar movement in the parallel linkage 14. In another embodiment, the link conduit can be located internally of the rim 60 to extend directly from the rotary coupling 66 to the tyre cavity.

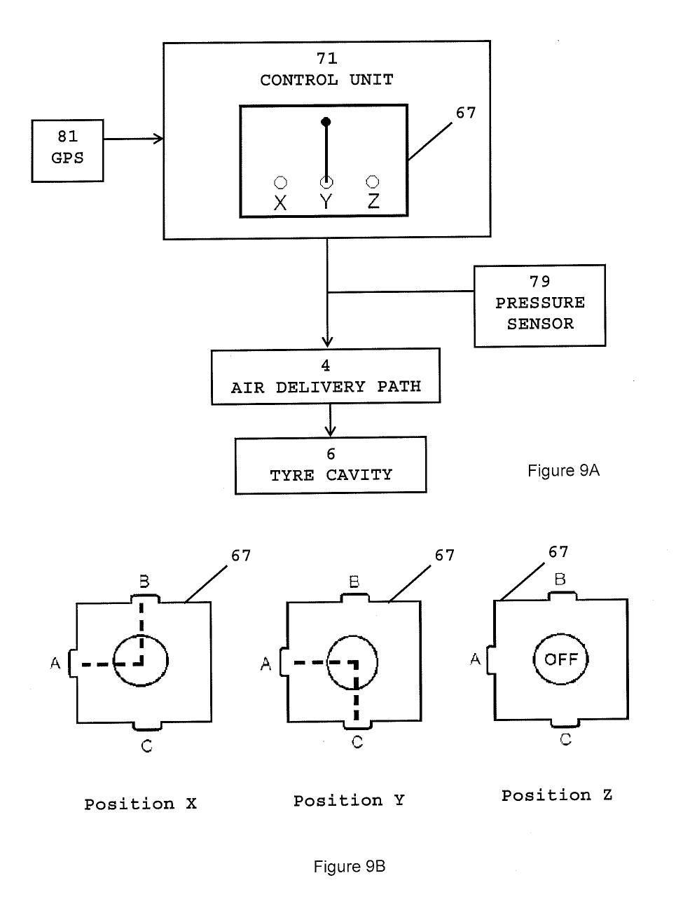

Turning to FIGS. 9A and 9B, the air flow controller comprises a pneumatic control unit 71 operable by an operator of the agricultural machine to control fluid flow through the supply conduit 70 and tyre conduit 68 to enable inflation or deflation of the tyre 62. The pneumatic control unit 71 comprises a three-way valve 67 capable of switching between three positions: X, Y and Z. The control unit 71 further comprises at least three ports A, B and C shown in FIG. 9B, wherein port A is connected to the supply conduit 70 (and thus the tyre conduit 68 and tyre cavity 6), port B is connected to a pressurised fluid source, and port C is connected to an exhaust outlet. As shown in FIG. 9B, when the valve 67 of the control unit is in position X, the valve 67 allows fluid communication between the supply conduit 70 and the pressurised fluid source (Port B), thereby enabling inflation of the tyre 62. When the valve 67 is in position Y, the supply conduit 70 is in communication with the exhaust (Port C), thereby enabling deflation of the tyre 62. In a third position Z, the valve 67 cuts off any communication between the ports A, B, C and therefore causes the current pressure in the tyre 62 to be maintained.

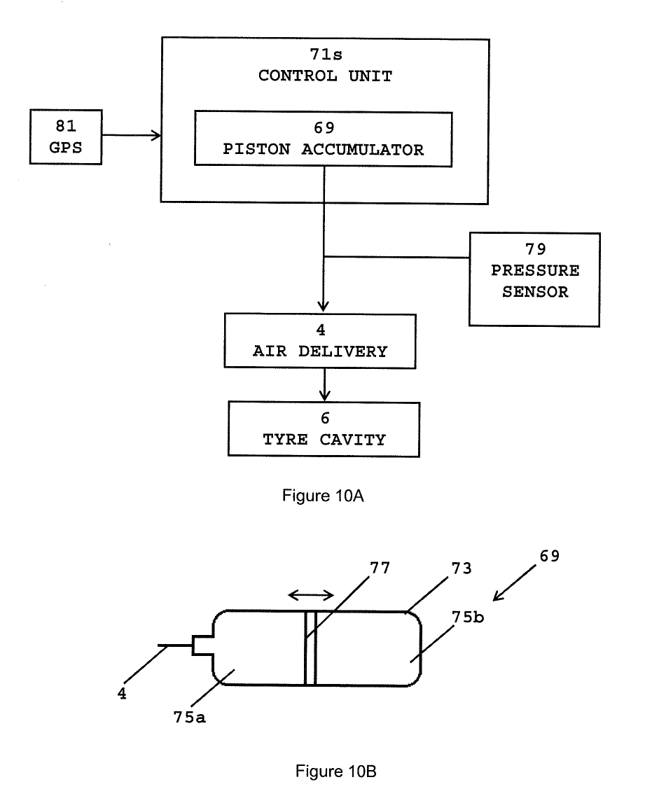

FIGS. 10A and 10B show an alternate embodiment of the control unit 71s. Instead of a three-way valve, inflation and deflation of the tyre 62 may be controlled by a pneumatic piston accumulator arrangement 69. In this embodiment, a cylinder 73 is separated into two chambers 75a and 75b by a piston 77. One chamber 75a is connected to the air delivery path 4 to deliver air into the tyre cavity 6. The other chamber 75b comprises compressible fluid and may be connected to a bladder or other vessel of compressible fluid. The control unit 71s may be arranged so that the piston 77 is movable manually or automatedly, for example using a motor. The pressure in the tyre 62 can be adjusted by moving the piston 77. More specifically, when the piston 77 is moved to the left, the air pressure in the tyre cavity 6 is increased since the volume of the chamber 75a is decreased, causing inflation of the tyre 62. When the piston 77 is moved to the right, the air pressure in the tyre cavity 6 is decreased since the volume of the chamber 75a is increased, thus deflating the tyre 62.

In either embodiment, a pressure sensor 79 may be connected in circuit with the air delivery path to the tyre 62 to monitor the tyre pressure. The pressure sensor can be positioned at a viewable location so that an operator can monitor the tyre pressure during inflation/deflation, and adjustment of the pressure carried out as required. Further, the control unit 71 or 71s may be configured with predetermined settings such that an operator can select a predetermined tyre pressure corresponding to a desired tyre profile. The control unit 71 or 71s will then automatically adjust the tyre pressure to that predetermined pressure, for example, using a pneumatic PD or PID controller. The control unit 71 or 71s may also be configured to receive user inputs to add or change the predetermined settings. It is further envisioned that either topographical maps or soil type maps can be associated with the predetermined settings and pneumatic control unit 71 or 71s, which can be further associated with a GPS system 81, so that the inflation or deflation of the tyre 62 can occur automatically as the planter assembly 10 traverses the paddock.

According to a further embodiment, the pneumatic control unit 71 or 71s will be operable remotely from the plough frame 12, for example from within a tractor towing the plough frame 12 so that an operator can cause inflation or deflation of the tyre 62 simultaneously while driving the tractor. In another embodiment, the pneumatic control unit can be mounted onto the plough frame 12, whereby the operator will need to first stop the tractor and then only cause inflation or deflation of the tyre 62. The pneumatic control unit 71 or 71 s can be simultaneously operatively joined to each planter assembly 10 joined to the plough frame 12 so that all the tyres 62 of the multitude of the planter assemblies 10 can be inflated or deflated concurrently.

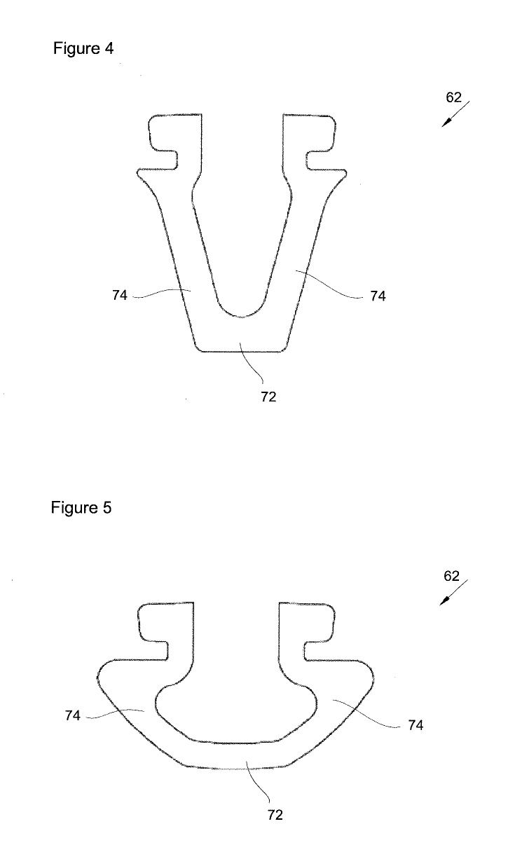

With reference to FIGS. 4 to 6, tyre 62 has a radial tread 72 and opposed sidewalls 74. When tyre 62 is substantially fully inflated it has a “tall” cross-section profile as shown in FIG. 4, wherein the width of the tread 72 is relatively small in comparison to the height of its sidewalls 74 thus resulting in the tyre 62 having a relatively small footprint, e.g. less than 10 cm². In use, the small footprint results in the press wheel 52 exerting a comparatively large downward pressure onto the soil to tightly compact the soil around the seed.

As tyre 62 is progressively deflated, the footprint of its tread 72 increases by lengthening radially and widening transversely, while the height of the sidewalls 74 adjacent the footprint decreases. Thus in a second profile after the tyre is partially deflated, as shown in FIG. 5, the tyre 62 has a “round” cross-section profile wherein the footprint of tread 72 is mid-sized, e.g. being 14-40 cm². In a third profile after the tyre is substantially deflated, as shown in FIG. 6, the tyre 62 has a “flat” cross-section profile wherein the footprint of tread 72 is large, e.g. greater than 100 cm². Thus, in use, these latter profiles shown in FIGS. 5 and 6 result in the press wheel 52 exerting progressively lesser downward pressure onto the soil to compress the soil less compactly around the seed.

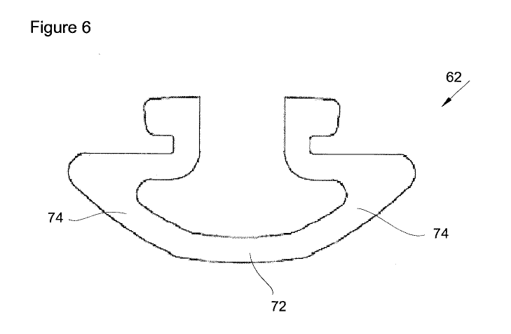

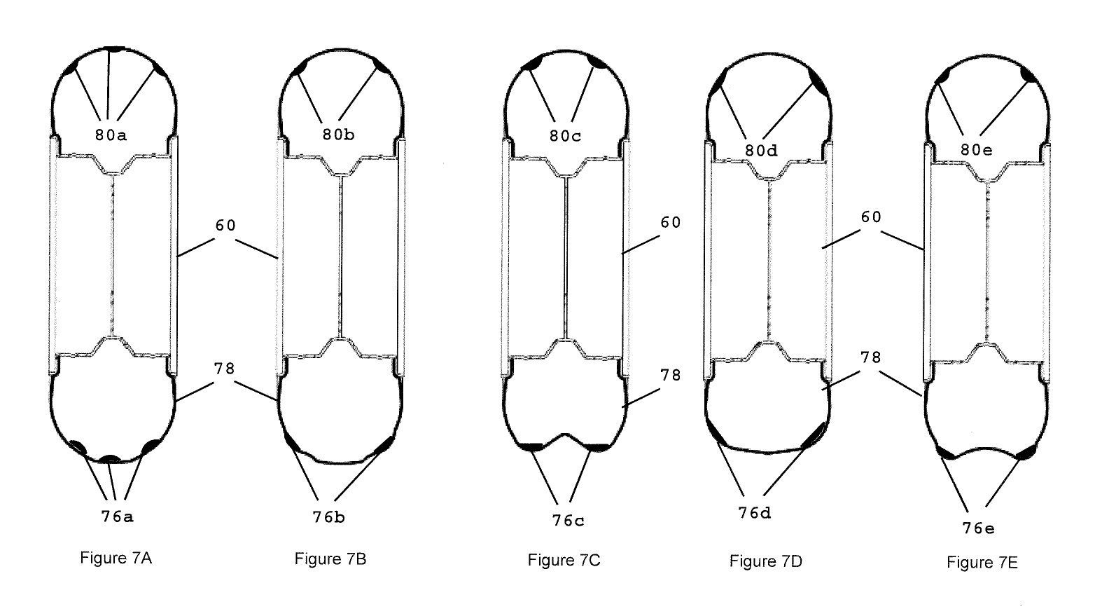

The above described changes in the profile can be achieved using a conventional type of tyre 62 for the press wheel 52. However, by suitably moulding the tyre 62 to have reinforced and weakened areas in its cross-section, it is possible to have the tread 72 predictably deform as it becomes deflated. In particular, with reference to the wheel cross-sections shown in FIGS. 7A-7E, a wall 78 of the tyre 62 may have one or more areas of defined different thickness 80 such that when the tyre 62 is substantially deflated, the tread of the tyre and the wall 78 are arranged to deform to a predetermined profile. In use, since a lower portion (at a given time) of a tyre 62 is pressed against underlying soil, the deflation profiles will occur at the lower portion, whereas an upper portion of the tyre 62 will remain substantially circular. Each of the FIGS. 7A-7E show a different deflated tyre profile as a result of areas of different thickness 80. The areas of different thickness 80 in these examples extend from an inner surface of the walls 78 and are formed in a continuous manner radially about a central axis of the tyres. In particular, each tyre 62 in FIGS. 7A-E comprises two or more spaced apart areas of different thickness 80. Three areas of increased thickness 80a are present in FIG. 7A that are relatively close together compared to two areas of increased thickness in each of FIGS. 7B, 7D and 7E. Further, the size, shape and locations of the areas of thickness 80c and 80e of the tyre in FIGS. 7C and 7E are such that at sufficient deflation, the tyre 62 defines a “W-shape” cross-sectional profile wherein the footprint of tread 72 forms two radial protuberances 76c and 76e, respectively. In use, these protuberances 76 cause greater compaction of the soil on either side of the furrow formed by the tine 34 while the tread 72 compacts the soil to a lesser extent over the seed. It will be appreciated that in yet further embodiments the areas of increased thickness 80 may be configured and disposed so as to produce a deflated cross-sectional profile of the tyre 62 having different desired shapes and/or any suitable number of radial protuberances.

The ability to change the profile of the tyre 62 provides several additional advantages. Firstly it enables and/or assists in the shedding of mud that tends to accumulate on the tyre 62 during use. In this regard, it will be appreciated that in many cases, the planter assembly 10 will be used in paddocks that contain damp or muddy soil. The damp soil often adheres to the tyre 62 as it traverses the paddock, which can increase drag on a tractor pulling the plough frame 12. Further, as the thickness of the mud layer increases it changes the radial dimension of the tyre 62 and thus the depth of the seed bed formed by the closing scraper 44, leading to incorrect seed placement. By deflating the tyre 62 to increase its footprint, the tyre 62 experiences a continuous change of its cross-section shape as it rotates around the axle 50. Thus the tyre 62 has its normal inflated cross-section shape (FIG. 4) when rotating about an upper half of the press wheel 52, but changes its cross-section shape to that shown in FIG. 5 or 6 when rotating about a lower half of the press wheel 52. The change in shape of the tyre 62 causes the mud to be more quickly shed from the tyre 62.

A second advantage provided by the changing profile is the ability to make small incremental changes to the depth of the seed bed formed by the closing scraper 44. As the tyre 62 is deflated, the radial height of tyre 62 between its footprint and the axle 50 decreases to lower the axle 50 closer to the soil surface. This lowering effects a lowering of the closing scraper 44 to lower the depth at which the seed bed is formed. Conversely, increasing the pressure in the tyre 62 increases its radial height and thus raises the closing scraper 44 and formation height of the seed bed. It will be appreciated that changes made by such inflation or deflation can provide incrementally continuous changes in the radial height of the tyre 62 and thus permits setting the seed bed at depths intermediate any regular discrete depth that may be set using the adjustment cog 56. Further, the changes to the inflation of the tyre 62 can be made while the planter assembly 10 is in operation and thus does not require stopping the operation as would be required to effect a change to the adjustment cog 56.

A further advantage is the ability for the tyre 62 to be inflated to a correct pressure depending on changing soil conditions in a paddock. Many paddocks are relatively large and have different soil conditions in different portions of the paddock, e.g. a first portion can be more sandy soil whereas a second portion can be more clay soil. Thus it is preferable to have a “tall” profile tyre 62 when traversing the sandy soil while having a flatter profile tyre 62 when traversing the clay soil. This is both to ensure the correct compression is applied to the soil surrounding a seed planted in the different soil types and also to ensure that the seed is planted at a constant depth across the paddock. The ability of the tyre 62 to be inflated and deflated during operation of the planter assembly 10, enables an operator to adjust the profile of the tyre 62 for the soil type as the planter assembly moves across the paddock.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. For example, in other embodiments of the invention, the agricultural implement 32 may not be attached to the linkage 14, but instead may be attached to another component of the agricultural machine, such as a portion of the plough frame 12. As another example, the planter assembly may be considered as including other components of the agricultural machine, such as the plough frame. It will also be appreciated that the agricultural machine may comprise a plurality of jump arms 48, and each jump arm 48 may support two or more press wheels, wherein the inflation system is arranged to adjust the inflation pressure of each press wheel supported by the jump arm 48. For example, each jump arm 48 may support a couple of press wheels or a “gang” (e.g. 4 to 6) of press wheels.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A tyre inflation system for an agricultural seeding machine having a jump arm supporting at least one press wheel, the tyre inflation system comprising:
an air delivery path arranged to be in air flow communication with a cavity of a tyre of a press wheel; and
an air flow controller operable to cause delivery of air through the air delivery path to adjust an inflation pressure of the tyre in situ during use of the agricultural seeding machine.

2. The tyre inflation system of claim 1, wherein the air delivery path is defined by:
a rotary coupling mountable to the press wheel;
a first air flow conduit arranged to extend from the rotary coupling to the air flow controller; and
a second air flow conduit for providing air flow communication between the rotary coupling and the cavity of the tyre.

3. The tyre inflation system of claim 2, wherein the rotary coupling is mountable on the axle of the wheel between the first and second air flow conduits.

4. The tyre inflation system as claimed in claim 1, wherein the air flow controller is operable to select between connecting the air delivery path to an air supply for increasing the inflation pressure of the tyre or an outlet for decreasing the inflation pressure of the tyre.

5. The tyre inflation system of claim 4, comprising a source of compressed air as the air supply.

6. The tyre inflation system as claimed in claim 1, wherein the air flow controller comprises a piston movable within a cylinder to change a volume of a chamber of the cylinder, wherein the chamber is in air flow communication with the air delivery path and moving the piston causes an increase or decrease in the inflation pressure of the tyre.

7. The tyre inflation system as claimed in claim 1, wherein the air delivery path extends through the axle and into the tyre.

8. The tyre inflation system as claimed in claim 2, wherein at least a portion of the first air flow conduit: extends through the jump arm, or; is flexible.

9. The tyre inflation system as claimed in claim 2, wherein the second air flow conduit: is rigid and extends from the rotary coupling to an inflation valve of the tyre, or; extends internally through the rim from the rotary coupling into the tyre.

10. The tyre inflation system as claimed in claim 1, wherein the in situ adjustment of the inflation pressure of the tyre is adapted to cause an in situ change of a cross-sectional profile of the tyre.

11. The tyre inflation system as claimed in claim 2, wherein the rotary coupling comprises a spindle adjoining the axle and a casing rotatably enclosing the spindle in an air tight manner.

12. A planter assembly for an agricultural machine, comprising:
at least one press wheel and a jump arm supporting the at least one press wheel in a manner wherein the at least one press wheel is arranged to follow a surface contour;
a pneumatic tyre mounted on each press wheel; and
a tyre inflation system as claimed in any one of the preceding claims.

13. A planter assembly as claimed in claim 12, wherein the tyre is arranged such that an area of the footprint of the tyre is variable between approximately 10 cm² and 100 cm².

14. A planter assembly as claimed in claim 12, wherein the tyre, when deflated to a sufficient extent, is arranged to have a cross-sectional profile having two or more radial protuberances.

15. A planter assembly as claimed in claim 12, comprising an agricultural implement joined either directly or indirectly to the jump arm, wherein adjustment of the inflation pressure of the tyre enables an adjustment of a working height of the agricultural implement.

16. A planter assembly as claimed in claim 12, comprising a linkage having a first end and a second end opposite the first end, wherein the first end is pivotally connectable to a plough frame and the second end is moveable in a plane of the linkage, wherein the jump arm joins the wheel to the linkage to cause movement of the second end as the wheel follows the surface contour during use.

17. A planter assembly as claimed in claim 12, wherein the pneumatic tyre comprises:
a wall defining an internal cavity of the tyre when mounted on a rim of the press wheel, the wall having one or more areas of thickness variation such that when pressure in the tyre is reduced, a cross-sectional profile of the wall deforms to a predetermined configuration as a result of the one or more areas of thickness variation.

18. A planter assembly as claimed in claim 12, comprising a control unit configured with predetermined settings such that an operator can select a predetermined tyre pressure corresponding to a desired tyre profile.

19. A planter assembly as claimed in claim 18, comprising a GPS device, wherein topographical maps or soil type maps are associated with the predetermined settings and the control unit is associated with the GPS system such that inflation or deflation of the tyre occurs automatically as the planter assembly traverses the paddock.

20. A pneumatic tyre for use with a press wheel of a planter assembly, the pneumatic tyre comprising:
a wall defining an internal cavity of the tyre when mounted on a rim of the press wheel, the wall having one or more areas of thickness variation such that when pressure in the tyre is reduced, a cross-sectional profile of the wall deforms to a predetermined configuration as a result of the one or more areas of thickness variation.

21. A pneumatic tyre as claimed in claim 20, wherein the cross-sectional profile is substantially W-shaped.
